(19) United States
(12) Patent Application Publication
(10) Pub. No.: US 2004/0070584 A1
(43) Pub. Date: Apr. 15, 2004

(54) 3-dimensional multiplanar reformatting system and method and computer-readable recording medium having 3-dimensional multiplanar reformatting program recorded thereon

(76) Inventors: Soon-Hyoung Pyo, Daejeon-city (KR); Yeong-Gil Shin, Seoul (KR); Jin-Wook Chung, Seoul (KR)

Correspondence Address: Shinjyu Global IP Counselors, Suite 700, 1233 Twentieth Street N W, Washington, DC, 20036, US

(21) Appl. No.: 10/432,730

(22) PCT Filed: Nov. 22, 2001
(86) PCT No.: PCT/KR01/02018

(30) Foreign Application Priority Data
Nov. 25, 2000 (KR) 200070724
Aug. 3, 2001 (KR) 200147025

(51) Int. Cl. G06T 15/00

(52) U.S. Cl. 345/419

(57) ABSTRACT

A three-dimensional multi-planar image reconstruction system and method, and a recording medium readable by a computer storing the same. A shape of a corresponding section is displayed as a user selects an image mode on a projected three-dimensional reference image. Then at least one sample point being the basis of generation of the corresponding multi-planar image is sampled from the shape of the section, upon the user selecting a region in any one form of a straight line, a curve, and a free-formed curve on the shape of the displayed section. At least one sample point is converted to three-dimensional coordinates and the vectors which is perpendicular to the projection plane is multiplied by the inverse matrix of the viewing matrix to generate a three-dimensional multi-planar image sampling direction vector. Finally, the values corresponding to the unit voxels are determined using the three-dimensional multi-planar image sampling direction vector to create and display the multi-planar image.

### TECHNICAL FIELD

The present invention relates to a three-dimensional multi-planar image reconstruction system and method, and a recording medium readable by a computer storing the multi-planar image. More specifically, the present invention relates to a three-dimensional multi-planar image reconstruction system and method for visualizing a multi-planar reconstruction image from a three-dimensional reference image of a body structure, and a recording medium readable by a computer storing the multi-planar image.

### BACKGROUND OF THE INVENTION

In general, three-dimensional multi-planar image reconstruction is technology that reconstructs a new two-dimensional image along a section of interest specified on a three-dimensional reference image in a linear form.

The 3-dimensional multi-planar image reconstruction system uses a coronal, sagittal, or axial image on the vertical plane of the whole volume as the reference image, and provides vertical, horizontal, and oblique lines as the presentation interfaces of the reconstructed image. In the system, the oblique line can be rotated to display the reconstructed image at a desired angle.

The 3-dimensional multi-planar image reconstruction system is widely used as a medical imaging technique (hereinafter referred to as “three-dimensional medical imaging technique”). In particular, the three-dimensional medical imaging technique refers to generation of a three-dimensional image from a two-dimensional medical image obtained by computed tomography (CT) or magnetic resonance imaging (MRI). Diagnosis using the two-dimensional image is disadvantageous with regard to difficulty in giving the three-dimensional effect to the whole image and viewing a region of interest. But the use of the three-dimensional medical imaging technique enables determination of the accurate position of the affected part and more realistic prediction of the operation method.

The conventional three-dimensional imaging programs provide multi-planar reconstruction from a two-dimensional image, as shown in FIG. 1. But these programs that generate images only in the direction perpendicular to the three-dimensional axis are problematic in extraction of a precise reconstruction image of a body structure having an inclined shape.

In addition, programs display the reconstruction image only in the linear form and have difficulty in extracting a section of an organ of interest.

### SUMMARY OF THE INVENTION

It is an object of the present invention to solve the problem with the two-dimensional multi-planar image reconstruction of the prior art and to provide a three-dimensional multi-planar image reconstruction system for reconstructing a multi-planar image directly from a three-dimensional image, and automatically generating an anatomical structure using the three-dimensional multi-planar reconstruction image.

It is another object of the present invention to provide a three-dimensional multi-planar image reconstruction method for reconstructing a multi-planar image directly from a three-dimensional image, and automatically generating an anatomical structure using the three-dimensional multi-planar reconstruction image.

It is further another object of the present invention to provide a recording medium readable by a computer storing the three-dimensional multi-planar image reconstruction method.

In one aspect of the present invention, there is provided a three-dimensional multi-planar image reconstruction system that includes: an input/storing section for externally receiving volume data containing density values of a three-dimensional structure having a defined characteristic, and storing the received volume data; a multi-planar image reconstructor for generating a three-dimensional reference image by rendering the volume data in the input/storing section, allowing a user to specifying a region of interest in the reference image, reconstructing a multi-planar image along the region of interest, and displaying the acquired multi-planar image; a display for displaying a three-dimensional image corresponding to the volume data stored in the input/storing section and a three-dimensional image corresponding to the region of interest designated by the user; and an input section for providing a drawing tool for the user to designate the region of interest on the displayed three-dimensional image, and sending a drawing request signal to the multi-planar image reconstructor in response to a drawing request from the drawing tool.

In another aspect of the present invention, there is provided a three-dimensional multi-planar image reconstruction method, which is to display a multi-planar image of a region of interest in a reference image, the method including: (a) displaying the shape of a corresponding section, upon a user selecting a desired image mode on a projected three-dimensional reference image; (b) sampling at least one sample point being the basis of generation of the corresponding multi-planar image from the shape of the section, upon the user selecting the region of interest in the form of any one of a straight line, a curve, and a free-formed curve on the shape of the corresponding section displayed; (c) converting the at least one sample point to three-dimensional coordinates; (d) multiplying the vector that is normal to a projection plane by the inverse matrix of a viewing matrix to generate a three-dimensional multi-planar image sampling direction vector; and (e) obtaining a value corresponding to a unit voxel from each sample point using the three-dimensional multi-planar image sampling direction vector to generate the multi-planar image, and displaying the generated multi-planar image.

The step (e) further includes: calculating each interval distance by interval-based integration using a curve equation passing control points; and summing the calculated interval distances in the order of the control point to calculate the total length of the curve from a zero point to the corresponding control point, and storing and displaying the total length of the curve.

Also, the step (e) further includes: providing a drawing tool including an oval, a free-formed curve, and a quadrangle for representation of the region of interest; sorting density values in the boundary of the region of interest; and assigning the sorted density values to the individual control points of an opacity transfer function to generate the three-dimensional image.

The desired image mode in the step (a) includes any one of a basic multi-planar image mode for sampling the individual points contained on a straight line representing a horizontal, vertical, or inclined plane and storing sample points; a curve multi-planar image mode for generating a curve from a plurality of control points entered by the user and viewing the shape of the corresponding section based on the generated curve; and a free-draw multi-planar image mode for viewing the shape of the corresponding section based on a given curve drawn by the user. The generation of the curve involves obtaining a function of the curve from the at least one input control point, substituting values of a constant interval for parameters to calculate the coordinates of the points, and connecting the corresponding points in a line segment. Preferably, the function of the curve is a Hermite curve equation.

The step (b) includes, when the shape of the displayed section is in a basic multi-planar image mode, sampling sample points at intervals of unit length from a straight line representing a plane selected by the user.

The step (b) includes, when the shape of the displayed section is in a curve multi-planar image mode, obtaining a direction unit vector of each line segment using the length and the direction vector of the corresponding line segment, and sampling the points from the one endpoint of the line segment to a point being apart from the one endpoint of the line segment at a distance of the direction unit vector.

Also, the step (b) includes, when the shape of the displayed section is in a free-draw multi-planar image mode, obtaining a direction unit vector of each line segment using the length and the direction vector 6 of the corresponding line segment and sampling the points from the one endpoint of the line segment to a point being apart from the one endpoint of the line segment at a distance of the direction unit vector.

Preferably, the conversion of the sample point to three-dimensional coordinates in the step (c) includes multiplying the coordinates on the projection plane of each sample point by an inverse matrix of viewing matrix A.

In further another aspect of the present invention, there is provided a recording medium readable by a computer storing a three-dimensional multi-planar image reconstruction method, which is to display a multi-planar image of a region of interest using a reference image, the method including: (a) displaying the shape of a corresponding section, upon a user selecting a desired image mode on a projected three-dimensional reference image; (b) sampling at least one sample point being the basis of generation of the corresponding multi-planar image from the shape of the section, upon the user selecting the region of interest in the form of any one of a straight line, a curve, and a free-formed curve on the shape of the corresponding section displayed; (c) converting the at least one sample point to three-dimensional coordinates; (d) multiplying the vector that is normal to a projection plane by the inverse matrix of a viewing matrix to generate a three-dimensional multi-planar image sampling direction vector; and (e) obtaining a value corresponding to a unit voxel from each sample point using the three-dimensional multi-planar image sampling direction vector to generate the multi-planar image, and displaying the generated multi-planar image.

The three-dimensional multi-planar image reconstruction system and method, and a recording medium readable by a computer storing the same, display a reconstructed section directly from a three-dimensional image to provide direct information about the region of interest, visualize predicted lesions on the three-dimensional image without checking the lesions from the three-dimensional image through two-dimensional multi-planar image reconstruction, and overcome the problem with the conventional image reconstruction methods restricted to the axis.

The total distance is displayed on the interfaces from the user's input device such as a mouse to provide numerical information and to re-extract the three-dimensional image using the multi-planar image, extracted from the numerical information.

Furthermore, the user can view a region of interest simply by selecting the region of interest on the multi-planar reconstruction image to automatically generate the opacity transfer function without representing the region of interest by way of the opacity transfer function.

### BRIEF DESCRIPTION OF THE DRAWINGS

The accompanying drawings, which are incorporated in and constitute a part of the specification, illustrate an embodiment of the invention, and, together with the description, serve to explain the principles of the invention.

FIG. 1 shows multi-planar reconstruction (MPR) images according to prior art;

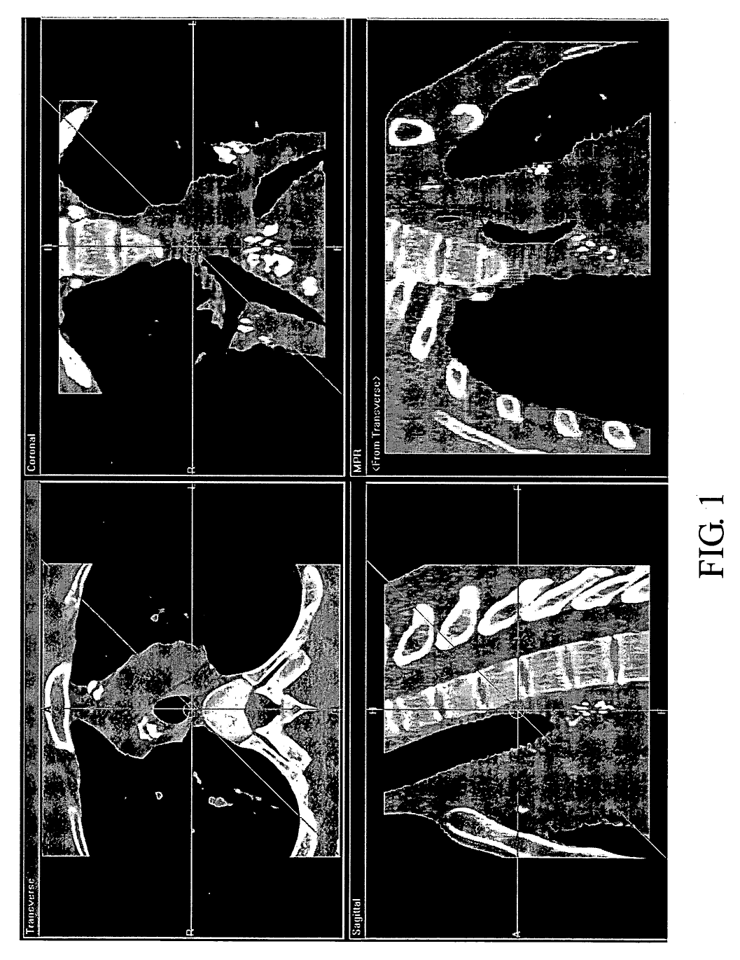

FIG. 2 is a schematic of a 3-dimensional multi-planar image reconstruction system in accordance with an embodiment of the present invention;

FIG. 3 is a flow chart showing a 3-dimensional multi-planar image reconstruction method in accordance with an embodiment of the present invention;

FIG. 4a shows an example of a reconstruction image using a basic interface according to the present invention;

FIG. 4b shows an example of a reconstruction image using a curve interface according to the present invention;

FIG. 4c shows an example of a reconstruction image using a free-draw interface according to the present invention;

FIG. 5 is an illustration of a section extracted using the basic interface shown in FIG. 4a;

FIG. 6 is an illustration of a section extracted using the curve interface shown in FIG. 4b;

FIG. 7 is an illustration of a reconstructed section extracted using the free-draw interface shown in FIG. 4c;

FIG. 8 is a flow chart showing a three-dimensional multi-planar image reconstruction method in accordance with another embodiment of the present invention;

FIG. 9 shows the summation of the interval-based distances on a curve containing control points;

FIG. 10 is a flow chart showing a three-dimensional multi-planar image reconstruction method in accordance with further another embodiment of the present invention; and

FIG. 11 shows an example of ROI (Regions Of Interest) determination using a multi-planar reconstruction image.

### DETAILED DESCRIPTION

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

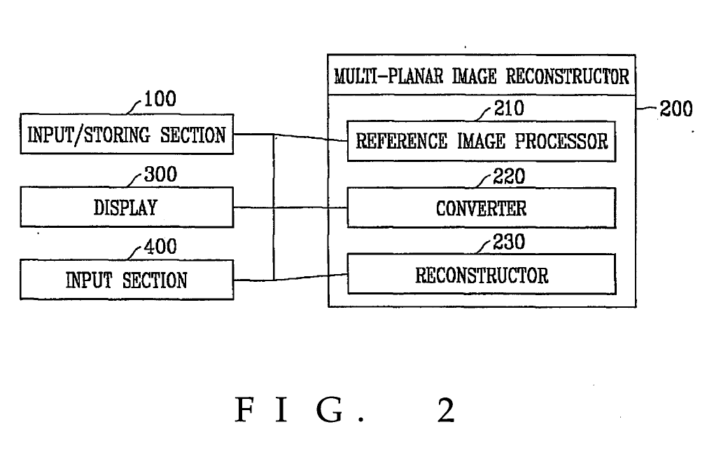

FIG. 2 is a schematic of a three-dimensional multi-planar image reconstruction system in accordance with an embodiment of the present invention.

Referring to FIG. 2, the three-dimensional multi-planar image reconstruction system according to the embodiment of the present invention comprises an input/storing section 100, a multi-planar image reconstructor 200, a display 300, and an input section 400.

The input/storing section 100 externally receives volume data containing density values of a three-dimensional structure having a predefined characteristic, and stores the received volume data for three-dimensional multi-planar image reconstruction.

The multi-planar image reconstructor 200, which comprises a reference image processor 210, a converter 220, and a reconstructor 230, displays the three-dimensional image of a three-dimensional structure based on the volume data stored in the input/storing section 100, and processes the displayed three-dimensional image to allow a user to perform image reconstruction using the three-dimensional image as a reference image and to display the multi-planar image of a region of interest displayed on the reference image.

More specifically, the reference image processor 210 processes the volume data stored in the input/storing section 100 to display the three-dimensional reference image from the volume data, and receives a region of interest entered by the user via the input section 400 in the form of straight line, curve, or free-formed curve data.

The converter 220 extracts three-dimensional coordinates corresponding to the individual points constituting a line, a curve, or a free-formed curve on the reference image fed into the reference image processor 210 from the two-dimensional position data of the points.

The reconstructor 230 acquires image information from the three-dimensional image using the three-dimensional coordinates corresponding to the individual points received from the converter 220 and the viewing vector of a multi-planar image of interest, and reconstructs the image information into a three-dimensional multi-planar image corresponding to a region of interest designated by the user from the volume data.

The display 300 displays the corresponding reference image, i.e., the three-dimensional image for the volume data stored in the input/storing section 100, and the three-dimensional multi-planar image corresponding to the region of interest designated by the user. Preferably, the three-dimensional image corresponding to the volume data is displayed on one side of the screen and the three-dimensional multi-planar image corresponding to the region of interest is displayed on the other side.

The input section 400 provides different drawing tools for the user to designate a region of interest on the corresponding reference image displayed, preferably on the three-dimensional image. Namely, the input section 400 sends a drawing request signal to the multi-planar image reconstructor 200 in response to the user's drawing request from a mouse or the like.

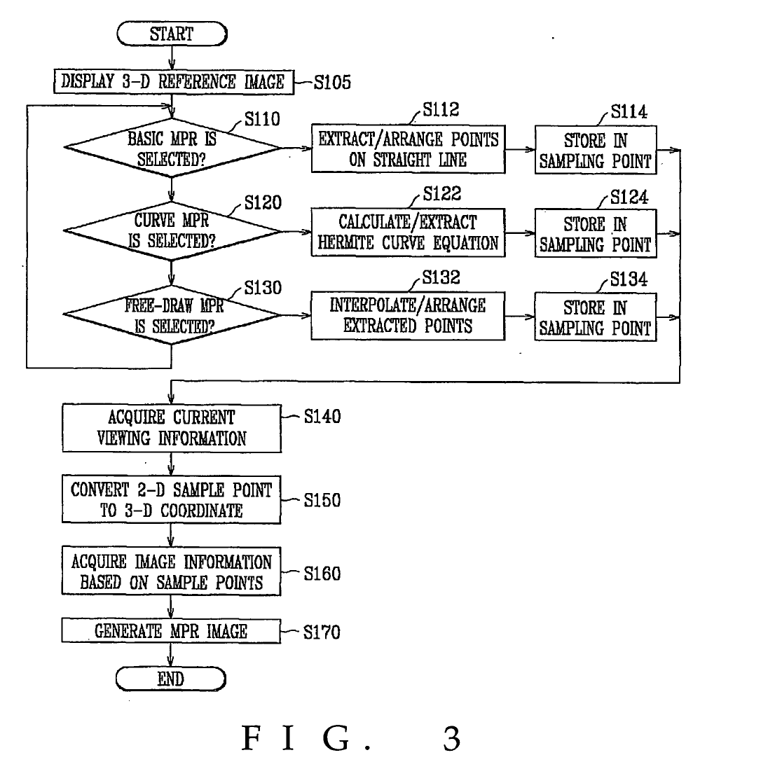

FIG. 3 is a flow chart showing a three-dimensional multi-planar image reconstruction method in accordance with the embodiment of the present invention, and in particular, of multi-planar image reconstruction on a three-dimensional image.

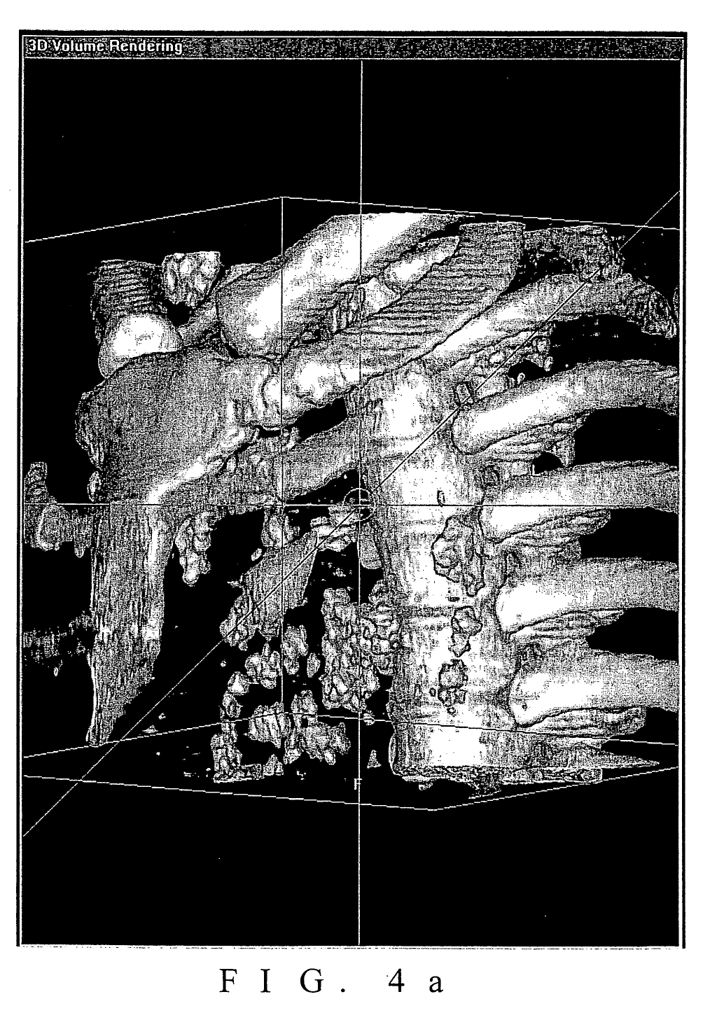

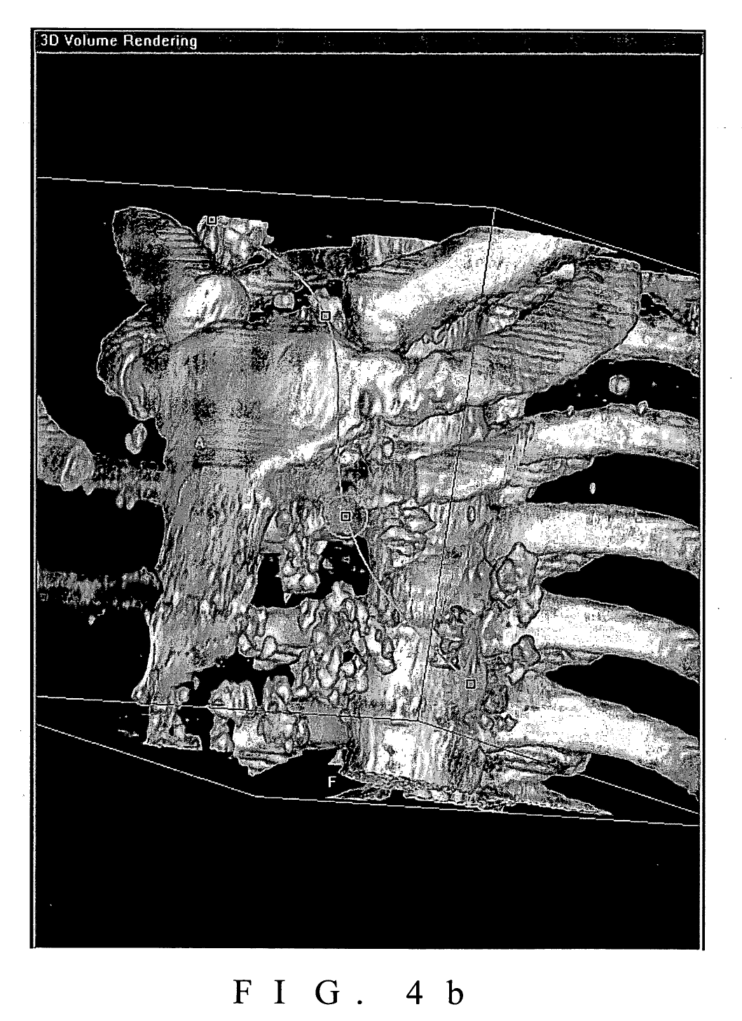

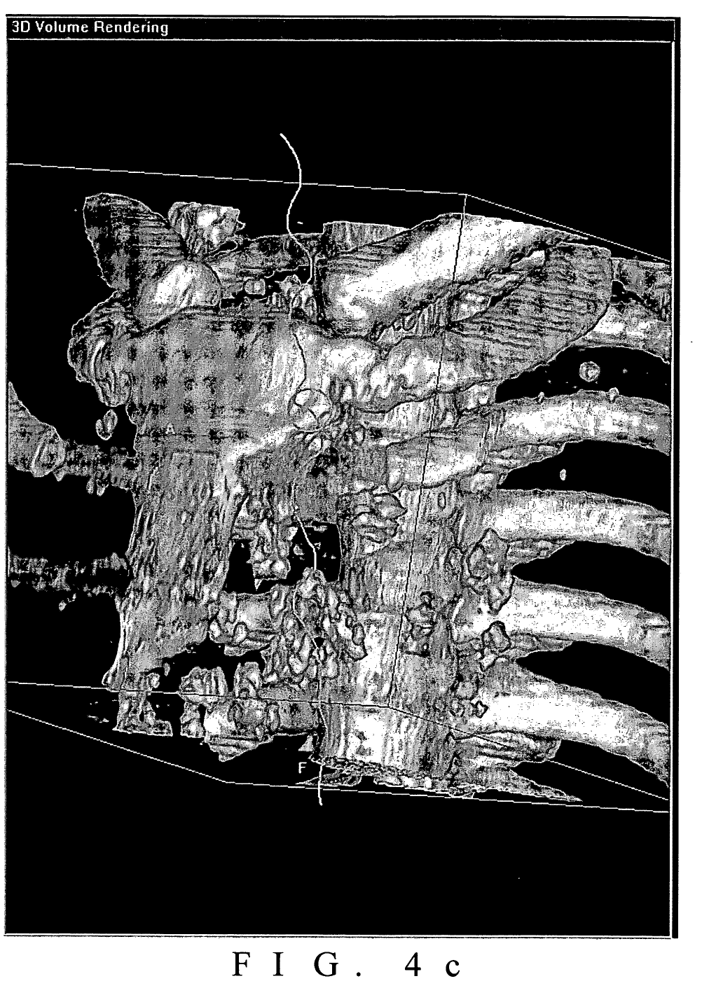

FIG. 4a shows an example of a reconstructed image using a basic interface according to the present invention, FIG. 4b shows an example of a reconstructed image using a curve interface according to the present invention, and FIG. 4c shows an example of a reconstructed image using a free-draw interface according to the present invention.

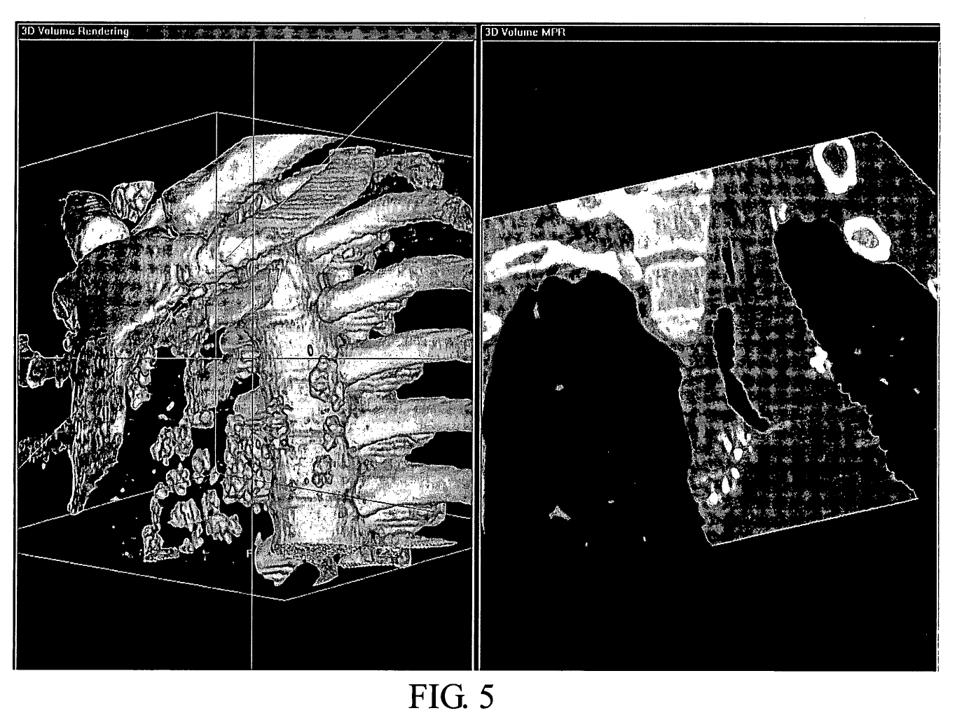

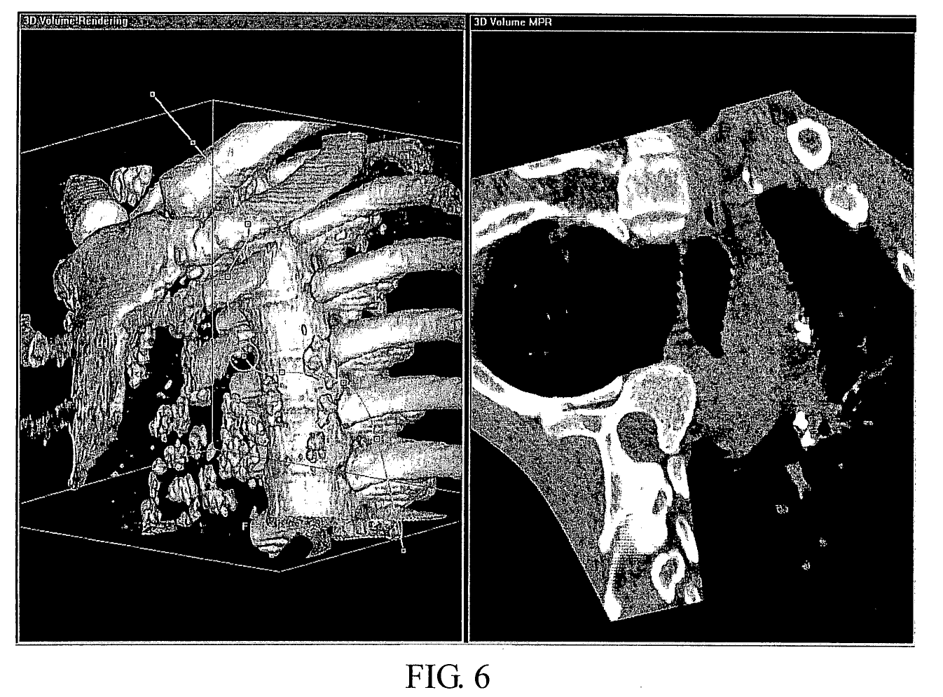

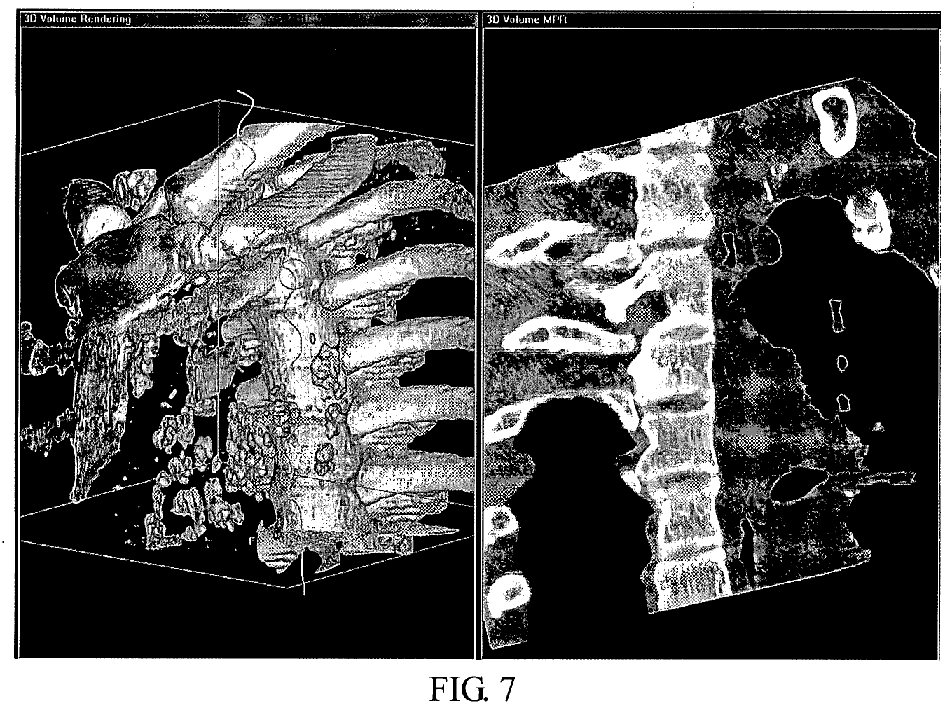

FIG. 5 is an illustration of a section extracted using the basic interface shown in FIG. 4a, FIG. 6 is an illustration of a section extracted using the curve interface shown in FIG. 4b, and FIG. 7 is an illustration of a reconstructed section extracted using the free-draw interface shown in FIG. 4c.

Referring to FIG. 3, as shown in FIGS. 4a, 4b, and 4c, the three-dimensional reference image is displayed, in step 105. To obtain a desired section with the three-dimensional volume data projected on the two-dimensional plane, the user has to select the region of interest on the three-dimensional reference image. The modules for entering information about the region of interest may include a basic MPR (Multi-Planar Reconstruction) module, a curve MPR module, or a free-draw MPR module.

The basic MPR module enables the system of the present invention to basically provide horizontal, vertical, and oblique lines presenting horizontal, vertical, and inclined planes on the three-dimensional reference image.

The horizontal and vertical planes cannot be rotated, but they are movable in parallel in the direction of the vector that is normal to each plane. The inclined plane is movable in parallel in the direction of the vector that is normal to each plane, and it can also be rotated on an axis being the vector that is normal to the screen. The lines presenting the respective planes perform the same operations. The user can view the shape of a region of interest by selecting, moving in parallel, or turning the respective lines, with a mouse.

The curve MPR module generates a curve from control points entered by the user, and allows the user to view the shape of a region of interest along the curve. For representation of the curve passing the control points, the curve MPR module obtains the function of the curve from the input control points using the Hermite curve equation or the like, substitutes values of a constant interval for parameters to calculate the coordinates of the points, and connects the points into a line segment.

The free-draw MPR module enables the user to view the shape of a region of interest based on a curve drawn with a mouse.

Returning to FIG. 31 it is checked in step 110 whether or not the user selects the basic MPR. If the basic MPR is chosen, the respective points of the straight line presenting a selected plane are sampled and arranged, in step 112. The sample points that are the basis in the generation of the corresponding MPR image, preferably the basic MPR image, are then stored, in step 114. Preferably, the basic MPR image comprises axial, sagittal, and coronal images.

The sample points are contained in a straight line (or curve) drawn (or selected) on the three-dimensional reference image by the user, and they become the points that constitute the one side (the left side or the lower base according to the direction of view) of the final MPR image. In the case of the basic MPR, the storage of the sample points is achieved by sampling the sample points at intervals of unit length from the straight line presenting the plane selected by the user.

If the basic MPR is not chosen in step 110, it is checked in step 120 whether or not the user selects the curve MPR composed of input control points. If the curve MPR is chosen, the Hermite curve equation is calculated using the input control points, in step 122, and the points between the control points are sampled at a constant interval using the Hermite curve equation to store the sample points, in step 124.

In the case of the curve MPR, the storage of the sample points is achieved by sampling the sample points at intervals of unit length from the line segment connecting the points used in drawing the curve. The sampling method involves obtaining the direction unit vector of each line segment using the length and the direction vector of the line segment, and sampling the points from the one endpoint of the line segment to the point being apart from the one endpoint of the line segment at a distance of the direction unit vector. After the completion of the sampling in one line segment, the same operation is performed in the next line segment.

When the curve MPR is not chosen in step 120, it is checked in step 130 whether or not the user selects the free-draw IVIPR using the input points chosen by the user with a mouse. If the free-draw MPR is not chosen, it returns to step 110; otherwise, if the free-draw MPR is chosen, the sample points are arranged by interpolation in step 132, and stored in step 134.

In the case of the free-draw MPR, the storage of the sample points is achieved by sampling the sample points at intervals of unit length from the line segment connecting the points used in drawing the curve, as in the case of the curve MPR.

Subsequent to steps 114, 124, and 134, the current viewing information is acquired, in step 140. To generate the MPR image directly from the three-dimensional volume data, the two-dimensional sample points obtained in the above procedures are converted to three-dimensional sample points, in step 150. More specifically, the conversion of the two-dimensional sample points to three-dimensional ones involves multiplying the coordinate of each point by the inverse matrix of viewing matrix A. Namely, P₃=A⁻¹ P₂, where P₃ is the three-dimensional coordinate of the sample point and P₂ is the coordinate of the sample point on the projection plane.

Subsequently, the image information is acquired based on each sample point, in step 160, to generate the corresponding MPR image, and the MPR image is displayed as shown in FIGS. 5, 6, and 7, in step 170.

More specifically, with the sample point converted to the three-dimensional coordinate, it is necessary to determine the direction of sampling in the three-dimensional coordinate space in acquisition of the MPR image starting from the sample point. That is, with the starting point and the sampling direction, the MPR image of one line can be generated every sample point. For the determination of the direction, the three-dimensional MPR image sampling direction vector is obtained by multiplying the vector that is normal to the projection plane, i.e., (0,0,1) by the inverse matrix of the viewing matrix, as in the three-dimensional conversion of the sample point.

The value corresponding to the unit voxel is then obtained using the direction vectors starting from the respective sample points. Applying this procedure to all the sample points obtains the MPR image.

Although the method for multi-planar image reconstruction from a three-dimensional image has been described above in accordance with one aspect of the present invention, the total distance information using the multi-planar image can also be acquired in another aspect of the present invention. More specifically, the three-dimensional IVIPR system of the present invention provides a function of displaying the total distance by intervals on the screen so that the user can check the distance between the intervals or the total distance.

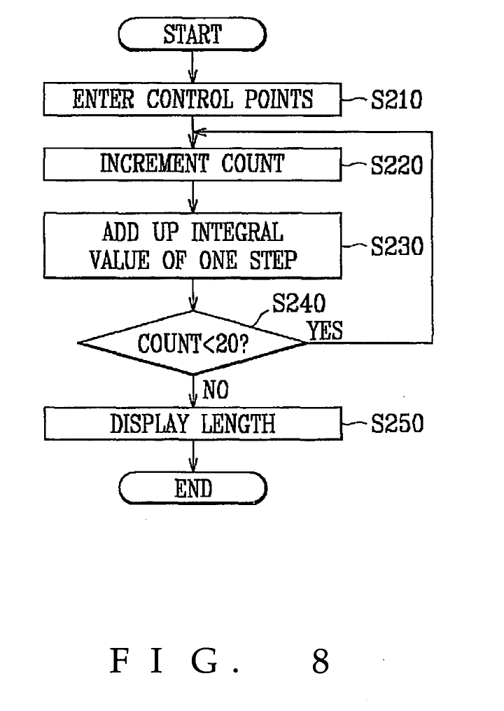

Now, a description will be given to a method for displaying the total distance with reference to FIG. 8.

FIG. 8 is a flow chart showing the three-dimensional multi-planar image reconstruction method in accordance with another embodiment of the present invention, in particular, the measurement of the total distance on a three-dimensional image.

Referring to FIG. 8, the user enters control points, in step 201, and the count value is incremented, in step 220. The integral value of one step is added up, in step 230. It is then checked in step 240 whether or not the count value is less than 20.

Namely, integration by intervals is performed using the curve equation passing the respective control points to obtain the distance of each interval, and the length of the curve from the zero point to each control point is summed in the order of the control points to display the summations beside the control points. The equation concerned is given as follows.

With the curve equation given by parameter u being (x(u), y(u)), the length L of the curve can be calculated as:

L=∫{square root over ((x′(u))²+(y′(u))²)} du=∫F(u)du (Equation 1)

The curve equation as used herein is the Hermite curve equation that is readily defined by control points, needs little calculation, and presents a smooth curve despite the small amount of calculation.

Constant integration is difficult to calculate on the actual codes. Hence, the parameter u ranging from “0” to “1” is divided into twenty equal parts, and the length of the curve is calculated using the mensuration by parts while increasing the value of u by 0.05. To minimize the error, the final result is the arithmetic mean of the sum of upper and lower integrals.

The integration-based calculation of the length can be performed during the editing of the curve or the addition of new control points, so that the user can check the cumulative length of the curve varied whenever the curve is edited or new control points are added.

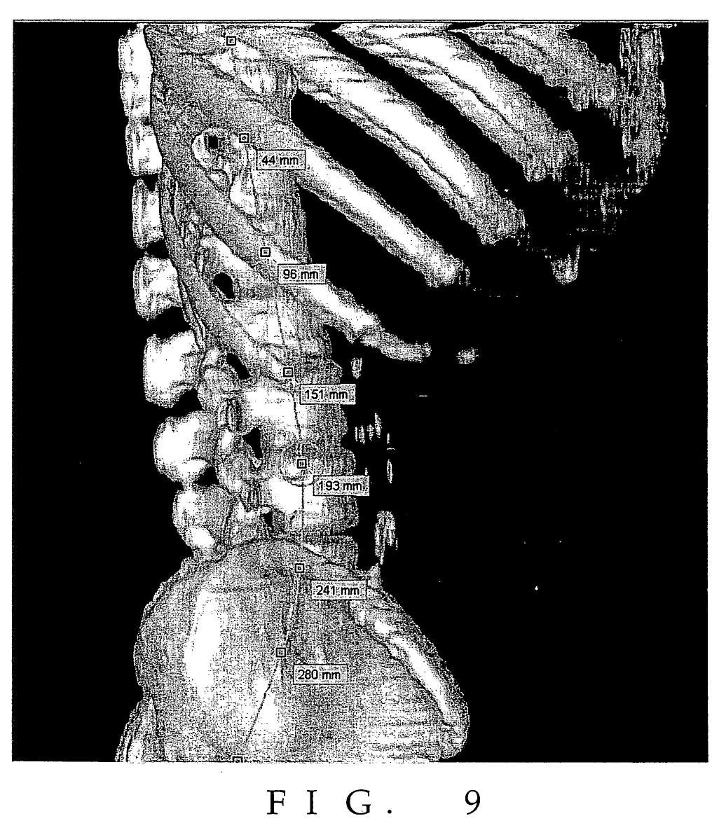

If the count value is less than 20 in step 240, it returns to step 220; otherwise, if the count value is 20, the length of the curve is displayed as shown in FIG. 9, in step 240. Here, the user can change the count value.

FIG. 9 shows the summation of the interval-based distances on a curve containing control points. The user can check the total distance and the interval-based distance from this information.

Though a method for acquiring the total distance information using the multi-planar image has been described above in another aspect of the present invention, it is also possible to automatically generate an anatomical structure by drawing a region of interest on the three-dimensional MPR image in accordance with further another aspect of the present invention, which will now be described, as follows.

Compared with the two-dimensional slices of CT or MRI, the three-dimensional reconstruction image showing a selected section of the structure provides much information about the region of interest.

Still another embodiment of the present invention method involves displaying a three-dimensional MPR image of the anatomical structure including a region of interest (ROI), and extracting the ROI from the image of the structure to analyze the density values of the corresponding region and to automatically generate an adequate opacity transfer function.

In particular, different drawing tools such as an oval, a free-formed curve, or a quadrangle are provided for the representation of the ROI.

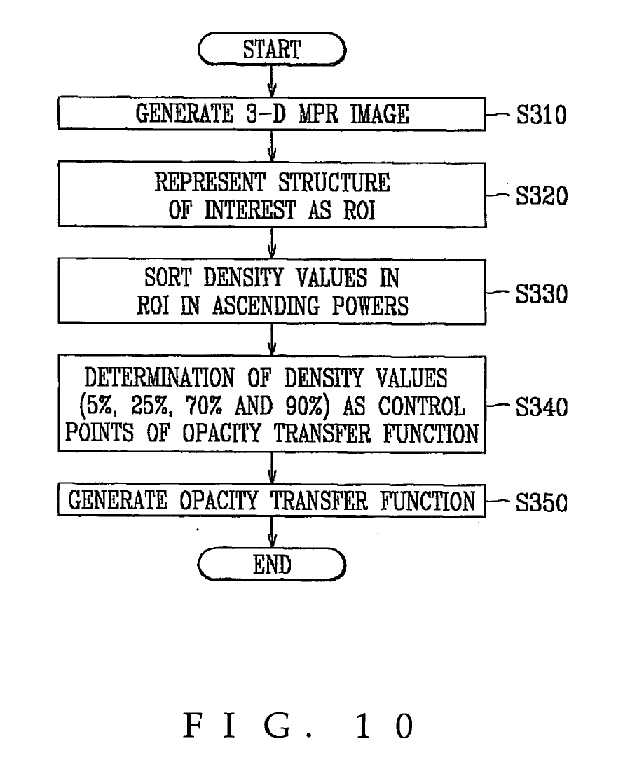

To generate the opacity transfer function for automatic representation of the ROI-specific anatomical structure, the density values in the boundary of the ROI are designated as 5%, 25%, 70%, and 95% in ascending powers and they are assigned to the respective control points of the opacity transfer function (trapezoidal). The user can change the percentage (%) corresponding to each control point. Now, the above method will be described in detail with reference to FIG. 10.

FIG. 10 is a flow chart showing a three-dimensional multi-planar image reconstruction method in accordance with still another embodiment of the present invention, particularly with respect to automated ROI extraction from a three-dimensional image.

Referring to FIG. 10, a three-dimensional MPR image is generated, in step 310.

The user represents a structure of interest with an ROI, in step 320, and the density values in the ROI are sorted, in step 330. Preferably, the density values are sorted in ascending powers.

The density values that amount to 5%, 20%, 70%, and 90% are assigned to the control points of the opacity transfer function, in step 340. It is of course evident that the density values assigned to the control points of the opacity transfer function are not limited to 5%, 25%, 70% and 90%.

Then the opacity transfer function is generated, in step 350.

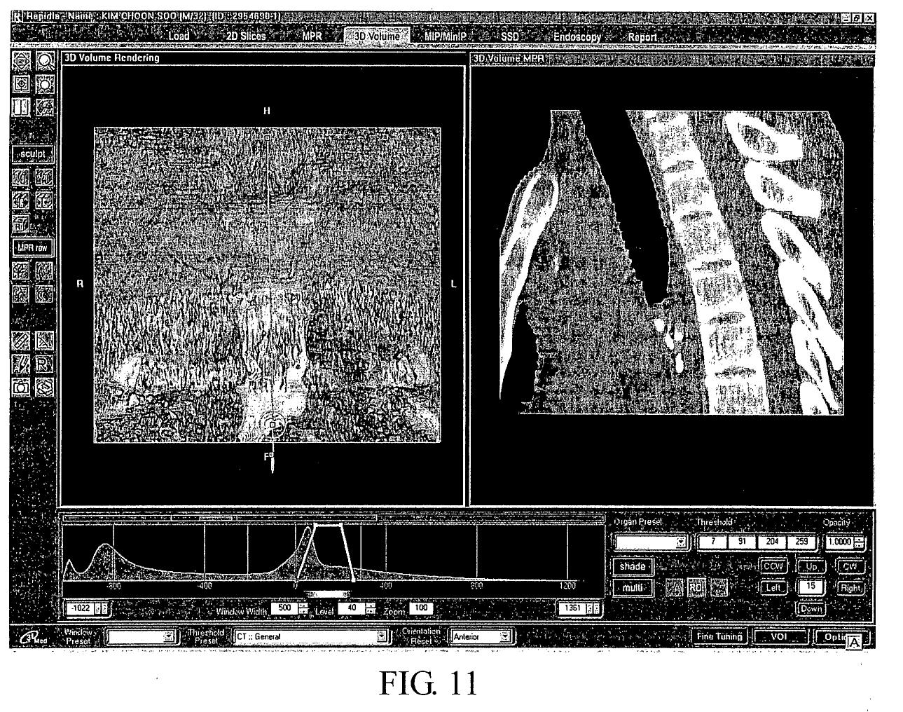

FIG. 11 shows an example of ROI determination on the MPR image. Once a desired three-dimensional MPR image is generated, a region of interest (ROI) is drawn. In FIG. 11, the ROI is expressed in a circle. Then, the corresponding opacity transfer function is generated as shown on the left bottom side of the image and the visualized result is shown on the left top side.

### INDUSTRIAL APPLICABILITY

The three-dimensional multi-planar image reconstruction method according to the present invention is not limited to the disclosed embodiments, but is intended to cover various modifications and equivalent arrangements within the spirit and scope of the appended claims. For example, the input section is not specifically limited to a mouse and may include a light pen, a keyboard, or other input devices. Also, the present invention can be widely applied to the design and construction of a three-dimensional structure such as an automobile, a vessel, or a building, as well as to the medical imaging systems.

While this invention has been described in connection with what is presently considered to be the most practical and preferred embodiment, it is to be understood that the invention is not limited to the disclosed embodiments, but on the contrary, is intended to cover various modifications and equivalent arrangements included within the spirit and scope of the appended claims.

As described above, the present invention allows the multi-planar image reconstruction system that plays an important part in medical diagnosis to overcome the problem with the conventional system in which the two-dimensional reconstruction function is limited to the axis, and to display a-region of interest directly on the three-dimensional image, thereby facilitating a more intuitive and accurate diagnosis.

The three-dimensional multi-planar image reconstruction of the present invention plays an important role as a guide in checking lesions of a patient and particularly overcomes the problem of the conventional software that provides a two-dimensional reconstruction function restricted to the axis, and enables representation of the lesions directly on a three-dimensional image, thus helping with an intuitive diagnosis and accurate determination and diagnosis of lesions.

Also, the present invention calculates the interval-based total distance for a curve containing control points, thus providing numerical information about the lesions; and it allows the user to directly enter a region of interest on an image instead of using numerals in re-extracting the three-dimensional image, by selecting the region of interest.

Furthermore, the present invention provides a function of automatically visualizing the anatomical structure using the ROI on the three-dimensional MPR image, and thus eliminates the need of the user's determining the opacity transfer function.

1. A three-dimensional multi-planar image reconstruction system comprising:
an input/storing section for externally receiving volume data containing density values of a three-dimensional structure having a defined characteristic, and storing the received volume data;
a multi-planar image reconstructor for displaying the spatial distribution of the three-dimensional structure in a three-dimensional image based on the volume data stored in the input/storing section, and processing the displayed three-dimensional image to allow a user to perform image reconstruction using the three-dimensional image as a reference image and to display a multi-planar image of a region of interest displayed on the reference image;
a display for displaying a three-dimensional image corresponding to the volume data stored in the input/storing section and a three-dimensional image corresponding to the region of interest designated by the user; and
an input section for providing a drawing tool for the user to designate the region of interest on the displayed three-dimensional image, and sending a drawing request signal to the multi-planar image reconstructor in response to a drawing request from the drawing tool.

2. The three-dimensional multi-planar image reconstruction system as claimed in claim 1, wherein the multi-planar image reconstructor comprises:
a reference image processor for allowing the three-dimensional reference image to be displayed from the volume data stored in the input/storing section, receiving the region of interest from the input section in the form of straight line or curve data on the reference image, and processing the received region of interest;
a converter for extracting three-dimensional coordinates of individual points from the two-dimensional position data of the points constituting a straight line or a curve on the reference image input to the reference input processor; and
a reconstructor for extracting data of each region of the image using the three-dimensional coordinates of the individual points obtained by the converter and a viewing vector of a desired multi-planar image, and reconstructing the data of each region into a multi-planar image of the region of interest.

3. A three-dimensional multi-planar image reconstruction method, which is to display a multi-planar image of a region of interest of a reference image, the method comprising:
(a) displaying the shape of a corresponding section, upon a user selecting a desired image mode on a projected three-dimensional reference image;
(b) sampling at least one sample point being the basis of generation of the corresponding multi-planar image from the shape of the section, upon the user selecting the region of interest in the form of any one of a straight line, a curve, and a free-formed curve on the shape of the corresponding section displayed;
(c) converting the at least one sample point to three-dimensional coordinates;
(d) multiplying the vector that is normal to a projection plane by the inverse matrix of a viewing matrix to generate a three-dimensional multi-planar image sampling direction vector; and
(e) obtaining a value corresponding to a unit voxel from each sample point using the three-dimensional multi-planar image sampling direction vector to generate the multi-planar image, and displaying the generated multi-planar image.

4. The three-dimensional multi-planar image reconstruction method as claimed in claim 3, wherein the step (e) further comprises:
calculating each interval distance by interval-based integration using a curve equation passing respective control points; and
summing the calculated interval distances in the order of the control points to calculate the total length of the curve from a zero point to the corresponding control point, and storing and displaying the total length of the curve.

5. The three-dimensional multi-planar image reconstruction method as claimed in claim 3, wherein the step (e) further comprises:
providing a drawing tool including an oval, a free-formed curve, and a quadrangle for representation of the region of interest;
sorting density values in the boundary of the region of interest; and
assigning the sorted density values to the individual control points of an opacity transfer function to generate the three-dimensional image.

6. The three-dimensional multi-planar image reconstruction method as claimed in claim 3, wherein the desired image mode in the step (a) comprises any one of a basic multi-planar image mode for sampling and arranging the individual points contained on a straight line representing a horizontal, vertical, or inclined plane and storing sample points; a curve multi-planar image mode for generating a curve from a plurality of control points entered by the user and viewing the shape of the corresponding section based on the generated curve; and a free-draw multi-planar image mode for viewing the shape of the corresponding section based on a given curve drawn by the user.

7. The three-dimensional multi-planar image reconstruction method as claimed in claim 6, wherein the generation of the curve comprises obtaining a function of the curve from the at least one input control point, substituting values of a constant interval for parameters to calculate the coordinates of the points, and connecting the corresponding points with a line segment.

8. The three-dimensional multi-planar image reconstruction method as claimed in claim 7, wherein the function of the curve comprises a Hermite curve equation.

9. The three-dimensional multi-planar image reconstruction method as claimed in claim 3, wherein the step (b) comprises, when the shape of the displayed section is in a basic multi-planar image mode, sampling sample points at intervals of unit length from a straight line representing a plane selected by the user.

10. The three-dimensional multi-planar image reconstruction method as claimed in claim 9, wherein the step (b) comprises, when the shape of the displayed section is in a curve multi-planar image mode, obtaining a direction unit vector of each line segment using the length and the direction vector of the corresponding line segment and sampling the points from the one endpoint of the line segment to a point being apart from the one endpoint of the line segment at each distance of the direction unit vector.

11. The three-dimensional multi-planar image reconstruction method as claimed in claim 9, wherein the step (b) comprises, when the shape of the displayed section is in a free-draw multi-planar image mode, obtaining a direction unit vector of each line segment using the length and the direction vector of the corresponding line segment and sampling the points from the one endpoint of the line segment to a point being apart from the one endpoint of the line segment at each distance of the direction unit vector.

12. The three-dimensional multi-planar image reconstruction method as claimed in claim 3, wherein the conversion of the sample point to three-dimensional coordinates in the step (c) comprises multiplying the coordinates on the projection plane of each sample point by an inverse matrix of viewing matrix A.

13. A recording medium readable by a computer storing a three-dimensional multi-planar image reconstruction method, which is to display a multi-planar image of a region of interest of a reference image, the method comprising:
(a) displaying the shape of a corresponding section, upon a user selecting a desired image mode on a projected three-dimensional reference image;
(b) sampling at least one sample point being the basis of generation of the corresponding multi-planar image from the shape of the section, upon the user selecting the region of interest in the form of any one of a straight line, a curve, and a free-formed curve on the shape of the corresponding section displayed;
(c) converting the at least one sample point to three-dimensional coordinates;
(d) multiplying the vector that is normal to a projection plane by the inverse matrix of a viewing matrix to generate a three-dimensional multi-planar image sampling direction vector; and
(e) obtaining a value corresponding to a unit voxel from each sample point using the three-dimensional multi-planar image sampling direction vector to generate the multi-planar image, and displaying the generated multi-planar image.

14. The recording medium readable by a computer storing a three-dimensional multi-planar image reconstruction method as claimed in claim 13, wherein the step (e) further comprises:
calculating each interval distance by interval-based integration using a curve equation passing respective control points; and
summing the calculated interval distances in the order of the control point to calculate the total length of the curve from a zero point to the corresponding control point, and storing and displaying the total length of the curve.

15. The recording medium readable by a computer storing a three-dimensional multi-planar image reconstruction method as claimed in claim 13, wherein the step (e) further comprises:
providing a drawing tool including an oval, a free-formed curve, and a quadrangle for representation of the region of interest;
sorting density values in the boundary of the region of interest in ascending powers; and
assigning the sorted density values to the individual control points of an opacity transfer function to generate the multi-planar image.
